(19) United States
(12) Patent Application Publication
(10) Pub. No.: US 2024/0405806 A1
(43) Pub. Date: Dec. 5, 2024

(54) RECONFIGURABLE SURFACE CONTROLLER CAPABILITY SIGNALING

(71) Applicant: QUALCOMM Incorporated, San Diego, CA (US)

(72) Inventors: Ahmed ELSHAFIE, San Diego, CA (US); Alexandros MANOLAKOS, Athens (GR); Yu ZHANG, San Diego, CA (US); Seyedkianoush HOSSEINI, San Diego, CA (US); Sony AKKARAKARAN, Poway, CA (US); Hung Dinh LY, San Diego, CA (US)

(21) Appl. No.: 18/697,306

(22) PCT Filed: Nov. 17, 2021
(86) PCT No.: PCT/CN2021/131097

§ 371 Date: Mar. 29, 2024

(51) Int. Cl. H04B 7/04; H04B 7/06; H04W 52/32

(52) U.S. Cl. CPC H04B 7/04013; H04B 7/0617; H04W 52/322

(57) ABSTRACT

Methods, systems, and devices for wireless communications are described. For instance, a first wireless device may receive, from a controller of a reconfigurable surface, an indication of a capability of the controller of the reconfigurable surface to perform one or more operations associated with communications between the controller and the first wireless device. The first wireless device may communicate first information with the controller of the reconfigurable surface based on receiving the indication of the capability and may communicate with a second wireless device via the reconfigurable surface, where an adjustment for the reconfigurable surface for communicating with the second wireless device is based on the first information.

### CROSS REFERENCE

The present application is a 371 national stage filing of International PCT Application No. PCT/CN2021/131097 by ELSHAFIE et al. entitled “RECONFIGURABLE SURFACE CONTROLLER CAPABILITY SIGNALING,” filed Nov. 17, 2021, which is assigned to the assignee hereof, and which is expressly incorporated by reference in its entirety herein.

### FIELD OF TECHNOLOGY

The following relates to wireless communications, including reconfigurable surface controller capability signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, a UE may communicate with a base station. For instance, the base station may transmit a first transmission to the UE and the UE may transmit a second transmission towards the base station in response to the first transmission. However, there may be examples in which the second transmission fails to arrive at the base station due to changes in the channel between the UE and the base station and/or changes in the positioning of the UE and the base station. Techniques that enable the base station to receive the second transmission may increase the efficiency of wireless communications between the UE and the base station.

### SUMMARY

The described techniques relate to improved methods, systems, devices, and apparatuses that support reconfigurable surface controller capability signaling. Generally, the described techniques provide for a wireless device to identify that a controller of a reconfigurable surface is capable of performing one or more operations for communications between the wireless device and another wireless device. For instance, a first wireless device may receive, from a controller of a reconfigurable surface, an indication of a capability of the controller of the reconfigurable surface to perform one or more operations associated with communications between the controller and the first wireless device. The first wireless device may communicate first information with the controller of the reconfigurable surface based on receiving the indication of the capability and may communicate with a second wireless device via the reconfigurable surface, where an adjustment for the reconfigurable surface for communicating with the second wireless device is based on the first information.

A method for wireless communication at a first wireless device is described. The method may include receiving, from a controller of a reconfigurable surface, an indication of a capability of the controller of the reconfigurable surface to perform one or more operations associated with communications between the controller and the first wireless device, communicating first information with the controller of the reconfigurable surface based on receiving the indication of the capability, and communicating with a second wireless device via the reconfigurable surface, where an adjustment for the reconfigurable surface for the communicating with the second wireless device is based on the first information.

An apparatus for wireless communication at a first wireless device is described. The apparatus may include a processor, memory coupled with the processor, and instructions stored in the memory. The instructions may be executable by the processor to cause the apparatus to receive, from a controller of a reconfigurable surface, an indication of a capability of the controller of the reconfigurable surface to perform one or more operations associated with communications between the controller and the first wireless device, communicate first information with the controller of the reconfigurable surface based on receiving the indication of the capability, and communicate with a second wireless device via the reconfigurable surface, where an adjustment for the reconfigurable surface for the communicating with the second wireless device is based on the first information.

Another apparatus for wireless communication at a first wireless device is described. The apparatus may include means for receiving, from a controller of a reconfigurable surface, an indication of a capability of the controller of the reconfigurable surface to perform one or more operations associated with communications between the controller and the first wireless device, means for communicating first information with the controller of the reconfigurable surface based on receiving the indication of the capability, and means for communicating with a second wireless device via the reconfigurable surface, where an adjustment for the reconfigurable surface for the communicating with the second wireless device is based on the first information.

A non-transitory computer-readable medium storing code for wireless communication at a first wireless device is described. The code may include instructions executable by a processor to receive, from a controller of a reconfigurable surface, an indication of a capability of the controller of the reconfigurable surface to perform one or more operations associated with communications between the controller and the first wireless device, communicate first information with the controller of the reconfigurable surface based on receiving the indication of the capability, and communicate with a second wireless device via the reconfigurable surface, where an adjustment for the reconfigurable surface for the communicating with the second wireless device is based on the first information.

In some examples of the method, apparatuses, and non-transitory computer-readable medium described herein, the indication of the capability of the controller includes an indication that the controller may be capable of decoding acknowledgement feedback for a wake-up signal and the method, apparatuses, and non-transitory computer-readable medium may include further operations, features, means, or instructions for transmitting, to the controller of the reconfigurable surface, the acknowledgement feedback for the wake-up signal based on receiving the indication that the controller may be capable of decoding the acknowledgement feedback for the wake-up signal.

In some examples of the method, apparatuses, and non-transitory computer-readable medium described herein, the first wireless device may be a first user equipment (UE) and the method, apparatuses, and non-transitory computer-readable medium may include further operations, features, means, or instructions for determining that the controller of the reconfigurable surface lacks a capability to decode acknowledgement feedback for a wake-up signal and transmitting the acknowledgement feedback for the wake-up signal to a second UE for relay to a serving base station based on determining that the controller of the reconfigurable surface lacks the capability.

Some examples of the method, apparatuses, and non-transitory computer-readable medium described herein may further include operations, features, means, or instructions for transmitting, to the controller of the reconfigurable surface, an indication of a control information reception mode for the controller, where communicating the first information may be based on the indication of the capability indicating that the controller may be configured for a first control information reception mode corresponding to monitoring one or more reception opportunities for the first information.

Some examples of the method, apparatuses, and non-transitory computer-readable medium described herein may further include operations, features, means, or instructions for transmitting, to the controller of the reconfigurable surface, a set of multiple indications of the control information reception mode for the controller, where each indication of the set of multiple indications may be associated with a time period.

Some examples of the method, apparatuses, and non-transitory computer-readable medium described herein may further include operations, features, means, or instructions for transmitting the indication of the control information reception mode for the controller may be based on a mobility of the first wireless device or the second wireless device, handover to the first wireless device or the second wireless device, or both.

Some examples of the method, apparatuses, and non-transitory computer-readable medium described herein may further include operations, features, means, or instructions for receiving, from the controller of the reconfigurable surface, an indication of a control information reception mode for the controller, where communicating the first information may be based on receiving the indication of the control information reception mode.

Some examples of the method, apparatuses, and non-transitory computer-readable medium described herein may further include operations, features, means, or instructions for receiving, from the controller of the reconfigurable surface, a set of multiple indications of the control information reception mode for the controller, where each indication of the set of multiple indications may be associated with a respective component carrier.

Some examples of the method, apparatuses, and non-transitory computer-readable medium described herein may further include operations, features, means, or instructions for receiving, from the controller of the reconfigurable surface, an indication of a class of controllers to which the controller belongs, where communicating the first information with the controller may be based on receiving the indication of the class of controllers to which the controller belongs.

In some examples of the method, apparatuses, and non-transitory computer-readable medium described herein, the first information includes a shared channel message indicating a set of beamforming weights and the adjustment of the reconfigurable surface may be based on the set of beamforming weights.

In some examples of the method, apparatuses, and non-transitory computer-readable medium described herein, the shared channel message includes a sidelink shared channel message indicating the set of beamforming weights, a sidelink control information message indicating the set of beamforming weights, a medium access control (MAC) control element message indicating the set of beamforming weights, or a downlink shared channel message indicating the set of beamforming weights.

In some examples of the method, apparatuses, and non-transitory computer-readable medium described herein, the indication of the capability includes an indication that the controller may be capable of decoding or encoding downlink control information messages, uplink control information messages, sidelink shared channel messages, downlink shared channel messages, uplink shared channel messages, sidelink control channel messages, or any combination thereof.

In some examples of the method, apparatuses, and non-transitory computer-readable medium described herein, the indication of the capability includes an indication that the controller may be capable of decoding or encoding a sequence-based non-coherent transmission, that the controller may be capable of performing polar decoding or polar encoding, that the controller may be capable of performing low-density parity check decoding or low-density parity check encoding, or any combination thereof.

A method for wireless communication at a controller of a reconfigurable surface is described. The method may include transmitting, to a first wireless device, an indication of a capability of the controller of the reconfigurable surface to perform one or more operations associated with communications between the controller and the first wireless device, communicating first information with the first wireless device based on transmitting the indication of the capability, and adjusting the reconfigurable surface for communications between the first wireless device and a second wireless device based on the first information.

An apparatus for wireless communication at a controller of a reconfigurable surface is described. The apparatus may include a processor, memory coupled with the processor, and instructions stored in the memory. The instructions may be executable by the processor to cause the apparatus to transmit, to a first wireless device, an indication of a capability of the controller of the reconfigurable surface to perform one or more operations associated with communications between the controller and the first wireless device, communicate first information with the first wireless device based on transmitting the indication of the capability, and adjust the reconfigurable surface for communications between the first wireless device and a second wireless device based on the first information.

Another apparatus for wireless communication at a controller of a reconfigurable surface is described. The apparatus may include means for transmitting, to a first wireless device, an indication of a capability of the controller of the reconfigurable surface to perform one or more operations associated with communications between the controller and the first wireless device, means for communicating first information with the first wireless device based on transmitting the indication of the capability, and means for adjusting the reconfigurable surface for communications between the first wireless device and a second wireless device based on the first information.

A non-transitory computer-readable medium storing code for wireless communication at a controller of a reconfigurable surface is described. The code may include instructions executable by a processor to transmit, to a first wireless device, an indication of a capability of the controller of the reconfigurable surface to perform one or more operations associated with communications between the controller and the first wireless device, communicate first information with the first wireless device based on transmitting the indication of the capability, and adjust the reconfigurable surface for communications between the first wireless device and a second wireless device based on the first information.

In some examples of the method, apparatuses, and non-transitory computer-readable medium described herein, the indication of the capability of the controller includes an indication that the controller may be capable of decoding acknowledgement feedback for a wake-up signal and the method, apparatuses, and non-transitory computer-readable medium may include further operations, features, means, or instructions for receiving, from the first wireless device, the acknowledgement feedback for the wake-up signal based on transmitting the indication that the controller may be capable of decoding the acknowledgement feedback for the wake-up signal.

Some examples of the method, apparatuses, and non-transitory computer-readable medium described herein may further include operations, features, means, or instructions for transmitting the acknowledgement feedback for the wake-up signal to the second wireless device based on receiving the acknowledgement feedback for the wake-up signal from the first wireless device.

Some examples of the method, apparatuses, and non-transitory computer-readable medium described herein may further include operations, features, means, or instructions for receiving, from the second wireless device, an indication of a location of the first wireless device and adjusting the reconfigurable surface to redirect a wake-up signal from the second wireless device to the first wireless device based on receiving the indication of the location of the first wireless device.

In some examples of the method, apparatuses, and non-transitory computer-readable medium described herein, the location of the first wireless device includes an angle associated with the first wireless device, a distance associated with the first wireless device, or both.

Some examples of the method, apparatuses, and non-transitory computer-readable medium described herein may further include operations, features, means, or instructions for transmitting, to the second wireless device, an indication of a number of repetitions corresponding to a set of resources and adjusting the reconfigurable surface to redirect, over each resource of the set of resources, a respective wake-up signal over a respective beam based on transmitting the indication of the number of repetitions.

Some examples of the method, apparatuses, and non-transitory computer-readable medium described herein may further include operations, features, means, or instructions for receiving, from the second wireless device and for each beam of a set of beams, an indication of an angle direction, an indication of a number of repetitions, an indication of a set of beamforming weights, or any combination thereof and adjusting the reconfigurable surface to redirect, for each beam of the set of beams, a respective wake-up signal based on the indication of the angle direction, the indication of the number of repetitions, the indication of the set of beamforming weights, or any combination thereof.

Some examples of the method, apparatuses, and non-transitory computer-readable medium described herein may further include operations, features, means, or instructions for receiving, from the first wireless device, an indication of a control information reception mode for the controller, where communicating the first information may be based on the indication of the control information reception mode indicating a first control information reception mode corresponding to monitoring one or more reception opportunities for the first information.

Some examples of the method, apparatuses, and non-transitory computer-readable medium described herein may further include operations, features, means, or instructions for receiving, from the first wireless device, a set of multiple indications of the control information reception mode for the controller, where each indication of indications may be associated with a time period.

Some examples of the method, apparatuses, and non-transitory computer-readable medium described herein may further include operations, features, means, or instructions for transmitting, to the first wireless device, an indication of a control information reception mode for the controller, where communicating the first information may be based on transmitting the indication of the control information reception mode.

Some examples of the method, apparatuses, and non-transitory computer-readable medium described herein may further include operations, features, means, or instructions for transmitting, to the first wireless device, a set of multiple indications of the control information reception mode for the controller, where each indication of the set of multiple indications may be associated with a respective component carrier.

Some examples of the method, apparatuses, and non-transitory computer-readable medium described herein may further include operations, features, means, or instructions for transmitting, to the first wireless device, an indication of a control information reception mode for the controller, where communicating the first information may be based on transmitting the indication of the control information reception mode.

Some examples of the method, apparatuses, and non-transitory computer-readable medium described herein may further include operations, features, means, or instructions for transmitting, to the first wireless device, an indication of a class of controllers to which the controller belongs, where communicating the first information with the first wireless device may be based on transmitting the indication of the class of controllers to which the controller belongs.

In some examples of the method, apparatuses, and non-transitory computer-readable medium described herein, the first information includes a shared channel transmission indicating a set of beamforming weights and the adjustment of the reconfigurable surface may be based on the set of beamforming weights

### BRIEF DESCRIPTION OF THE DRAWINGS

FIG. 1 illustrates an example of a wireless communications system that supports reconfigurable surface controller capability signaling in accordance with aspects of the present disclosure.

FIG. 2 illustrates an example of a wireless communications system that supports reconfigurable surface controller capability signaling in accordance with aspects of the present disclosure.

FIG. 3 illustrates an example of a feedback scheme that supports reconfigurable surface controller capability signaling in accordance with aspects of the present disclosure.

FIG. 4 illustrates an example of a feedback scheme that supports reconfigurable surface controller capability signaling in accordance with aspects of the present disclosure.

FIG. 5 illustrates an example of a process flow that supports reconfigurable surface controller capability signaling in accordance with aspects of the present disclosure.

FIGS. 6 and 7 show block diagrams of devices that support reconfigurable surface controller capability signaling in accordance with aspects of the present disclosure.

FIG. 8 shows a block diagram of a communications manager that supports reconfigurable surface controller capability signaling in accordance with aspects of the present disclosure.

FIG. 9 shows a diagram of a system including a device that supports reconfigurable surface controller capability signaling in accordance with aspects of the present disclosure.

FIGS. 10 and 11 show block diagrams of devices that support reconfigurable surface controller capability signaling in accordance with aspects of the present disclosure.

FIG. 12 shows a block diagram of a communications manager that supports reconfigurable surface controller capability signaling in accordance with aspects of the present disclosure.

FIG. 13 shows a diagram of a system including a device that supports reconfigurable surface controller capability signaling in accordance with aspects of the present disclosure.

FIGS. 14 through 16 show flowcharts illustrating methods that support reconfigurable surface controller capability signaling in accordance with aspects of the present disclosure.

### DETAILED DESCRIPTION

A reconfigurable surface (e.g., a reconfigurable intelligent surface (RIS)) may redirect (e.g., reflect, refract) transmissions between wireless devices (e.g., uplink transmissions, downlink transmissions, sidelink transmissions). In some examples, a controller coupled with the RIS may have a capability to perform one or more communications operations with a wireless device according to a particular radio access technology (RAT) (e.g., New Radio (NR), 5G, Long Term Evolution (LTE), Long Term Evolution Advanced (LTE-A), LTE-A Pro). However, if a wireless device fails to identify which communications operations the controller of the reconfigurable surface is capable of performing, the wireless device may fail to perform the one or more communications operations with the reconfigurable surface or may attempt to perform a communications operation with the controller of the reconfigurable surface that the controller is not capable of performing. Accordingly, the efficiency of wireless communications may decrease.

The present disclosure describes methods that enable wireless devices communicating with a controller of the reconfigurable surface to identify one or more communications operations that the controller of the reconfigurable surface may include capability for performing. For instance, the controller of the reconfigurable surface may transmit an indication of its capabilities to perform certain communications operations to a wireless device. Such capabilities may include, for instance, the controller being capable of decoding or encoding certain types of signaling. Additionally, the controller may indicate a class of controller that the controller belongs to, where each class is associated with a different set of supported communications operations. In some examples, a wireless device may transmit, to the controller, a request to update a control information reception mode of the controller (e.g., a request to monitor or to refrain from monitoring control information). Additionally, or alternatively, the controller may transmit, to the wireless device, an indication of a control information reception mode for the controller (e.g., whether the controller is monitoring for control information).

Additionally, the controller of the reconfigurable surface may indicate that it is capable of receiving acknowledgement (ACK) feedback from a first wireless and device or for a wake-up signal (WUS). In some such examples, the controller may be capable of forwarding the ACK feedback to a second wireless device (e.g., the wireless device that transmitted the WUS to the first wireless device). If the controller of the reconfigurable surface indicates that it is not capable of receiving and/or decoding an ACK from the first wireless device, the first wireless device may transmit the ACK to a third wireless device (e.g., a user equipment (UE)) that may relay the ACK to the second wireless device.

Aspects of the disclosure are initially described in the context of wireless communications systems. Additional aspects of the disclosure are described in the context of feedback schemes and a process flow. Aspects of the disclosure are further illustrated by and described with reference to apparatus diagrams, system diagrams, and flowcharts that relate to reconfigurable surface controller capability signaling.

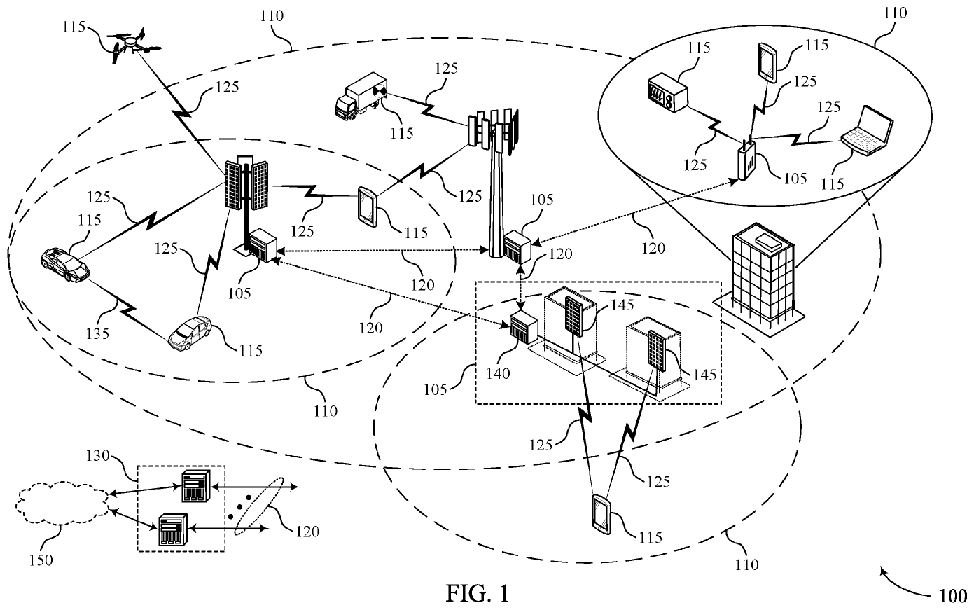

FIG. 1 illustrates an example of a wireless communications system 100 that supports reconfigurable surface controller capability signaling in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a controller of a reconfigurable surface may have a transceiver that supports some or each features or operations of a RAT (e.g., NR, LTE).

With functionality supporting some or each of the features or operations, the controller may engage in activities in the network that may improve the performance of the network. For instance, the controller may announce its capabilities for the RAT (e.g., to UEs 115, base stations 105, or surrounding nodes) and/or announce whether it is monitoring for control information (e.g., in an active mode) or refraining from monitoring for control information (e.g., in a passive mode). Additionally, the controller may announce an ability to decode downlink control information (DCI), uplink control information (UCI), a physical sidelink control channel (PSCCH) transmission, a physical sidelink shared channel (PSSCH) transmission, a physical sidelink feedback channel (PSFCH) transmission, or any combination thereof. Announcing this information may enable the controller to participate in a positioning procedure and/or a WUS procedure. The present disclosure may describe operations that the controller may perform based on one or more capabilities of the controller and features of a RAT that the controller implements (e.g., a capability to assist in waking up a UE 115 or a set of UEs 115).

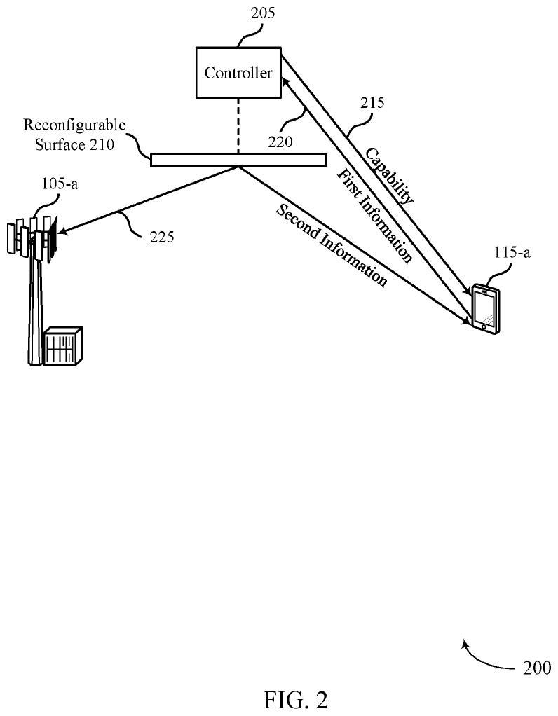

FIG. 2 illustrates an example of a wireless communications system 200 that supports reconfigurable surface controller capability signaling in accordance with aspects of the present disclosure. In some examples, wireless communications system 200 may implement one or more aspects of wireless communications system 100. For instance, UE 115-a may be an example of a UE 115 as described with reference to FIG. 1 and base station 105-a may be an example of a base station 105 as described with reference to FIG. 1. In some examples, a base station 105 or a first node may perform the operations of UE 115-a and/or a UE 115 or a second node may perform the operations of base station 105-a without deviating from the scope of the present disclosure.

Controller 205 may be coupled with reconfigurable surface 210, which may be an example of a RIS. In some examples, controller 205 may transmit, to UE 115-a, an indication of a capability 215 of the controller 205. The capability 215 may indicate that the controller 205 may decode physical uplink control channel (PUCCH) transmissions and/or sequence-based non-coherent transmissions. Additionally, or alternatively, the capability 215 may indicate that the controller 205 supports polar decoding (e.g., NR polar decoding) and/or that the controller 205 may decode DCI and/or UCI. In some examples, the capability 215 may indicate a specific type of DCI and/or UCI. Additionally, or alternatively, the capability 215 may indicate that the controller 205 supports low-density parity-check (LDPC) decoding over certain component carriers dedicated for reconfigurable surfaces and/or that the controller 205 supports decoding physical downlink shared channel (PDSCH) transmissions, physical uplink shared channel (PUSCH) transmissions, PSSCH transmissions, or any combination thereof. In some such examples in which the controller 205 indicates that it supports LDPC decoding, PUSCH decoding, PDSCH decoding, PSSCH decoding, or any combination thereof, base station 105-a and/or UE 115-a may send information via one or more of these shared channels for configuration of the reconfigurable surface. For example, base station 105-a and/or UE 115-a may send a weight matrix to controller 205, in which case controller 205 may configure the reconfigurable surface for redirecting signals between the base station 105-a, UE 115-a, or other UEs. Additionally, or alternatively, the capability 215 may indicate that the controller 205 supports encoding, decoding, or both on different channels (e.g., the controller may decode one or more channels but may not perform transmitting).

In some examples, the capability 215 may indicate one type or class of reconfigurable surface controllers to which the controller 205 may belong. For instance, each class or type may contain one or more NR functionalities or operations that the controller 205 supports. In some such examples, UE 115-a and/or base station 105-a may be configured with a set of classes or types of reconfigurable surfaces. In some examples, (e.g., if the controller 205 and/or the reconfigurable surface 210 is in a fixed location), base station 105-a may indicate, to UE 115-a, the one type or class of the controller 205. In one example, a first class of reconfigurable surface controllers (e.g., Class A) may have full functionalities for a RAT (e.g., NR). For instance, fully functional uplink, downlink, and sidelink communications may be supported. A second class of reconfigurable surface controllers (e.g., Class B) may have reduced capacity compared to Class A controllers. A third class of reconfigurable surface controllers may be capable of performing a first combination of operations such as LDPC decoding, sequence-based PUCCH transmission, physical downlink control channel (PDCCH) reception, PSSCH communications, and PSFCH communications. A fourth class of reconfigurable surface controllers may be capable of performing a second combination of operations such as LDPC decoding and encoding and may be capable of communicating PUCCH transmissions, PDCCH transmissions, and PSCCH transmissions. A fifth class of reconfigurable surface controllers may be capable of performing a third combination of operations such as receiving information to configure the reconfigurable surface for reflecting one or more signals to represent binary encoding using a signal sent by another device (e.g., controller 205 is used to change phases or coefficients of elements of the reconfigurable surface 210).

In some examples, base station 105-a (e.g., or a controlling UE 115) may send a request to controller 205 to operate in a first control information reception mode (e.g., an active mode) or a second control information reception mode (e.g., a passive mode). The first control information reception mode may be associated with controller 205 monitoring for control information (e.g., UCI, DCI, sidelink control information (SCI)) and the second control information reception mode may be associated with controller 205 refraining from monitoring for the control information. In some examples, base station 105-a may send the request based on a mobility of one or more UEs 115 (e.g., including UE 115-a) and/or a handover of one or more UEs 115 (e.g., including UE 115-a). The request to operate in the first control information mode or the second control information mode may be periodic, where base station 105-a may indicate that controller 205 is to monitor for control information (e.g., a DCI) at a certain periodicity (e.g., every X milliseconds). Accordingly, the controller 205 may refrain from tracking each transmission directed towards controller 205 (e.g., the controller 205 may be in the second control information reception mode between instances of receiving the request). Additionally, or alternatively, controller 205 may dynamically indicate whether it operates in one control information reception mode only or both the first control information reception mode and the second control information reception mode. In some examples, controller 205 may dynamically indicate whether it operates in one control reception mode only or both control reception modes on a per component carrier index basis.

In some examples, the controller 205 may support LDPC decoding. In some such examples, the controller 205 may perform one or more operations to aid in refining a beamforming matrix associated with controller 205. Base station 105-a (e.g., using PDSCH) or a UE 115-a (e.g., using PSSCH or a second stage SCI (SCI-2)) may send first information 220 (e.g., a weight matrix) to controller 205. Additionally, or alternatively, MAC-CE signaling may indicate the first information 220 (e.g., weight matrix). Based on the first information 220, controller 205 may adjust the reconfigurable surface 210 for communications between UE 115-a and base station 105-a. After reconfigurable surface 210 is adjusted, UE 115-a may communicate second information 225 with base station 105-a via the reconfigurable surface 210, which may redirect (e.g., reflect, refract) the second information 225.

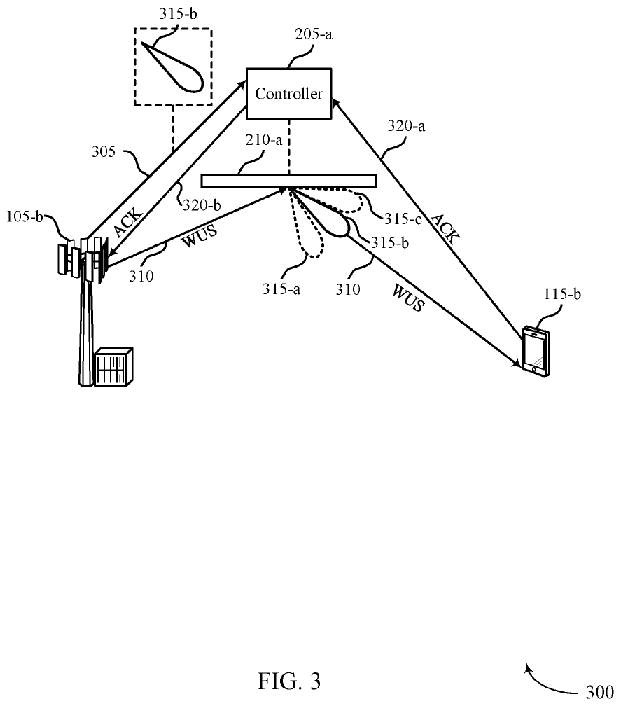

In some examples, base station 105-a may transmit a WUS to UE 115-a via reconfigurable surface 210. In some such examples, UE 115-a may transmit a corresponding ACK to controller 205, which may relay the ACK to base station 105-a. Additional details may be described herein, for instance, with reference to FIG. 3. Additionally, or alternatively, UE 115-a may transmit the corresponding ACK to another UE 115, which may relay the ACK to base station 105-a. Additional details may be described herein, for instance, with reference to FIG. 1.

The method described herein may be associated with one or more advantages. For instance, controller 205 signaling a capability 215 may enable the controller 205 to perform one or more communications operations that increase the efficiency of wireless communications. For instance, controller 205 may relay an ACK from UE 115-a to base station 105-a. Additionally, or alternatively, controller 205 may adjust the reconfigurable surface 210 based on a received weight matrix, which may enable base station 105-a to communicate a transmission with UE 115-a with a higher SNR.

FIG. 3 illustrates an example of a feedback scheme 300 that supports reconfigurable surface controller capability signaling in accordance with aspects of the present disclosure. In some examples, feedback scheme 300 may implement one or more aspects of wireless communications systems 100 and/or 200. For instance, UE 115-b may be an example of a UE 115 as described with reference to FIG. 1 and/or a UE 115-a as described with reference to FIG. 2. Additionally, or alternatively, base station 105-b may be an example of a base station 105 as described with reference to FIG. 1 and/or a base station 105-a as described with reference to FIG. 2. Additionally, or alternatively, controller 205-a may be an example of a controller 205 as described with reference to FIG. 2 and reconfigurable surface 210-a may be an example of a reconfigurable surface 210 as described with reference to FIG. 2. In some examples, a base station 105 or a first node may perform the operations of UE 115-b and/or a UE 115 or a second node may perform the operations of base station 105-b without deviating from the scope of the present disclosure.

Controller 205-a may be coupled with reconfigurable surface 210-a, which may be an example of a RIS. In some examples, base station 105-b may transmit information 305 to controller 205-a associated with one or more UEs 115 (e.g., including UE 115-b) that may enable controller 205-a to refine beams to aid in waking up the one or more UEs 115 (e.g., via a WUS 310). In some examples, base station 105-a may perform training to sweep weights on reconfigurable surface 210-a. For instance, base station 105-b may transmit an indication of a location of UEs 115 to be woken up to controller 205-a, which may include an angle of the one or more UEs 115, a distance to the one or more UEs 115, or any combination thereof. Additionally, or alternatively, base station 105-a may signal angle direction, a number of repetitions, or weights (e.g., beamforming weights), or any combination thereof to be used for each direction. In some examples, controller 205-a may send a request to base station 105-a with a number of repetitions for one or more beams. Based on the information 305 received from base station 105-b, controller 205-a may determine a set of weights corresponding to a beam 315-b (e.g., as opposed to a beam 315-a and/or 315-c) and may adjust the reconfigurable surface 210-a according to the set of weights.

In some examples, base station 105-a may transmit a WUS 310 towards reconfigurable surface 210-a. Reconfigurable surface 210-a may redirect (e.g., refract, reflect) WUS 310 towards UE 115-a according to the set of weights corresponding to beam 315-b. If controller 205-a is capable of decoding acknowledgement feedback (e.g., capable of performing PUCCH decoding, such as PUCCH format 0 decoding or PFSCH), UE 115-b may transmit acknowledgement feedback 320-a (e.g., an ACK if UE 115-b receives and successfully decodes WUS 310 or a negative acknowledgement (NACK) if UE 115-b fails to receive or decode WUS 310) to controller 205-a. Controller 205-a, after receiving acknowledgement feedback 320-a, may transmit acknowledgement feedback 320-b (e.g., a relayed or forwarded version of acknowledgement feedback 320-a) to base station 105-b.

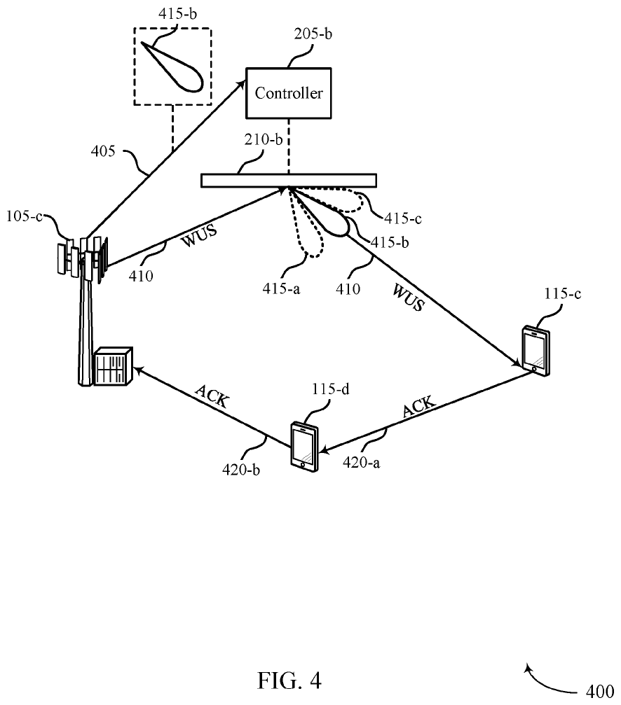

FIG. 4 illustrates an example of a feedback scheme 400 that supports reconfigurable surface controller capability signaling in accordance with aspects of the present disclosure. In some examples, feedback scheme 400 may implement one or more aspects of wireless communications systems 100 and/or 200. For instance, UEs 115-c and 115-d may each be an example of a UE 115 as described with reference to FIG. 1 and/or a UE 115-a as described with reference to FIG. 2. Additionally, or alternatively, base station 105-c may be an example of a base station 105 as described with reference to FIG. 1 and/or a base station 105-a as described with reference to FIG. 2. Additionally, or alternatively, controller 205-b may be an example of a controller 205 as described with reference to FIG. 2 and reconfigurable surface 210-b may be an example of a reconfigurable surface 210 as described with reference to FIG. 2. In some examples, a base station 105 or a first node may perform the operations of UE 115-c and/or a UE 115 or a second node may perform the operations of base station 105-c without deviating from the scope of the present disclosure.

Controller 205-b may be coupled with reconfigurable surface 210-b, which may be an example of a RIS. In some examples, base station 105-c may transmit information 405 to controller 205-b associated with one or more UEs 115 (e.g., including UE 115-c) that may enable controller 205-b to refine beams to aid in waking up the one or more UEs 115 (e.g., via a WUS 410). In some examples, base station 105-b may perform training to sweep weights on reconfigurable surface 210-b. For instance, base station 105-b may transmit an indication of a location of UEs 115 to be woken up to controller 205-b, which may include an angle of the one or more UEs 115, a distance to the one or more UEs 115, or any combination thereof. Additionally, or alternatively, base station 105-b may signal angle direction, a number of repetitions, or weights (e.g., beamforming weights), or any combination thereof to be used for each direction. In some examples, controller 205-b may send a request to base station 105-c with a number of repetitions for one or more beams. Based on the information 405 received from base station 105-c, controller 205-b may determine a set of weights corresponding to a beam 415-b (e.g., as opposed to a beam 415-a and/or 415-c) and may adjust the reconfigurable surface 210-b according to the set of weights.

In some examples, base station 105-c may transmit a WUS 410 towards reconfigurable surface 210-b. Reconfigurable surface 210-b may redirect (e.g., refract, reflect) WUS 410 towards UE 115-c according to the set of weights corresponding to beam 415-b. If controller 205-b is incapable of decoding acknowledgement feedback (e.g., incapable of performing PUCCH decoding, such as PUCCH format 0 decoding or PFSCH), UE 115-c may transmit acknowledgement feedback 420-a (e.g., an ACK if UE 115-c receives and successfully decodes WUS 410 or a negative acknowledgement (NACK) if UE 115-c fails to receive or decode WUS 410) to UE 115-d. UE 115-d, after receiving acknowledgement feedback 420-a, may transmit acknowledgement feedback 420-b (e.g., a relayed or forwarded version of acknowledgement feedback 420-a) to base station 105-c. In the present example, both UE 115-c and controller 205-b may be capable of decoding DCI.

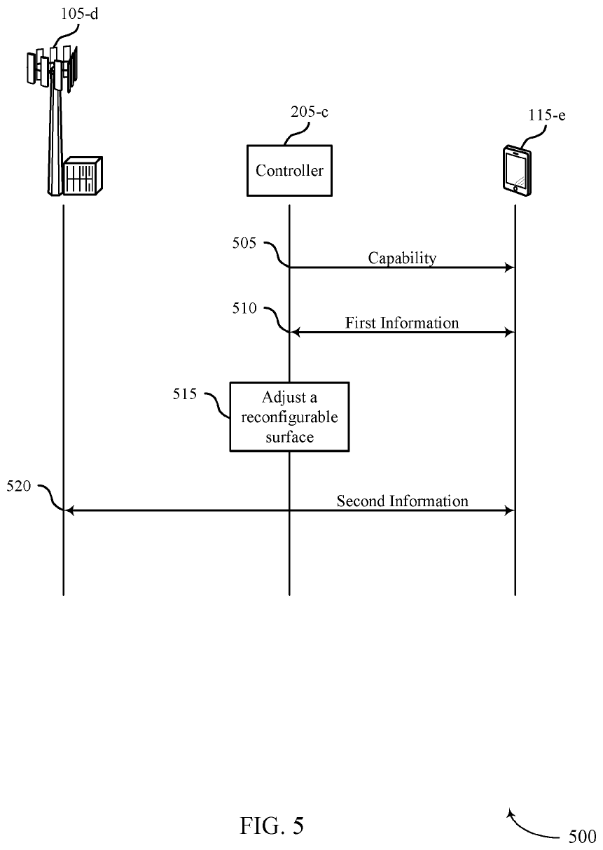

FIG. 5 illustrates an example of a process flow 500 that supports reconfigurable surface controller capability signaling in accordance with aspects of the present disclosure. In some examples, process flow 500 may implement one or more aspects of wireless communications systems 100 and/or 200. For instance, UE 115-e may be an example of a UE 115 as described with reference to FIG. 1 and/or a UE 115-a as described with reference to FIG. 2. Additionally, or alternatively, base station 105-d may be an example of a base station 105 as described with reference to FIG. 1 and/or a base station 105-a as described with reference to FIG. 2. Additionally, or alternatively, controller 205-c may be an example of a controller 205 (e.g., a controller of a reconfigurable surface) as described with reference to FIG. 2.

At 505, controller 205-c may transmit, to UE 115-e, an indication of a capability of controller 205-c to perform one or more operations associated with communications between controller 205-c and UE 115-e. In some examples, the indication of the capability includes an indication that controller 205-c is capable of decoding acknowledgement feedback for a WUS. In some such examples, UE 115-e may transmit, to controller 205-c, the acknowledgement feedback for the WUS based on receiving the indication that the controller is capable of decoding the acknowledgement feedback. In some examples, controller 205-c may transmit (e.g., relay), to base station 105-d, the acknowledgement feedback received from UE 115-e. Additionally, or alternatively, UE 115-e may determine that controller 205-c lacks a capability to decode acknowledgement feedback for a WUS and may transmit the acknowledgement feedback directly to base station 105-d (e.g., using a higher number of repetitions) or to a second UE for relay to base station 105-d based on determining that controller 205-c lacks the capability.

In some examples, controller 205-c may transmit, to UE 115-e, an indication of a class of controllers to which controller 205-c belongs. In some such examples, communicating the first information with controller 205-c may be based on receiving the indication of the class of controllers. In some examples, the first information includes a shared channel message indicating a set of beamforming weights. Additionally, the first information may be included in a sidelink shared channel message (e.g., a PSSCH message), a sidelink control information message (e.g., a PSCCH), a MAC-CE message, or a downlink shared channel message (e.g., a PDSCH message).

In some examples, the indication of the capability includes an indication that controller 205-c is capable of decoding or encoding DCI messages, UCI messages, sidelink shared channel messages (e.g., PSSCH messages), downlink shared channel messages (e.g., PDSCH messages), uplink shared channel messages (e.g., PUSCH messages), sidelink control channel messages (e.g., PSCCH messages), or any combination thereof. Additionally, or alternatively, the indication of the capability includes an indication that controller 205-c is capable of decoding or encoding a sequence-based non-coherent transmission, that controller 205-c is capable of performing polar decoding or polar encoding, that controller 205-c is capable of performing LDPC decoding or LDPC encoding, or any combination thereof.

At 510, controller 205-c may communicate, with UE 115-e, first information based on controller 205-c transmitting the indication of the capability to UE 115-e. In some examples, UE 115-e may transmit, to controller 205-c, an indication of a control reception mode for controller 205-c. In some such examples, communicating the first information may be based on the capability indicating that controller 205-c is configured for a first control information reception mode corresponding to monitoring one or more reception opportunities for the first information. Additionally, in some such examples, UE 115-e may transmit, to controller 205-c, a set of indications of the control information reception mode for controller 205-c, where each indication of the set if associated with a time period. Additionally, or alternatively, UE 115-e may transmit the indication of the control information reception mode based on a mobility of UE 115-e or base station 105-d, handover to UE 115-e or base station 105-d, or both. Additionally, or alternatively, controller 205-c may transmit, to UE 115-e, an indication of a control information reception mode for controller 205-c, where communicating the first information is based on transmitting the indication of the control information reception mode to UE 115-e. In some such examples, controller 205-c may transmit, to UE 115-e, a set of indications of the control information reception mode for controller 205-c, where each indication is associated with a respective component carrier.

At 515, controller 205-c may adjust the reconfigurable surface for communications between UE 115-e and base station 105-d based on the first information. In examples in which the first information includes the shared channel message, the adjustment of the reconfigurable surface may be based on the set of beamforming weights. In some examples, controller 205-c may receive, from base station 105-d, an indication of a location of UE 115-e and may adjust the reconfigurable surface to redirect a WUS from base station 105-d to UE 115-e based on receiving the indication of the location. In some examples, the location of UE 115-e may include an angle associated with UE 115-e, a distance associated with UE 115-e, or both. Additionally, or alternatively, controller 205-c may transmit, to base station 105-d, an indication of a number of repetitions corresponding to a set of resources and may adjust the reconfigurable surface to redirect, over each resource of the set of resources, a respective WUS over a respective beam based on transmitting the indication of the number of repetitions. Additionally, or alternatively, base station 105-d may transmit, to controller 205-c and for each beam of a set of beams, an indication of an angle direction, an indication of a number of repetitions, an indication of a set of beamforming weights, or any combination thereof. In some such examples, base station 105-d may adjust the reconfigurable surface to redirect, for each beam of the set of beams, a respective WUS based on the indication of the angle direction, the indication of the number of repetitions, the indication of the set of beamforming weights, or any combination thereof.

At 520, UE 115-e may communicate, with base station 105-d, second information via the reconfigurable surface.

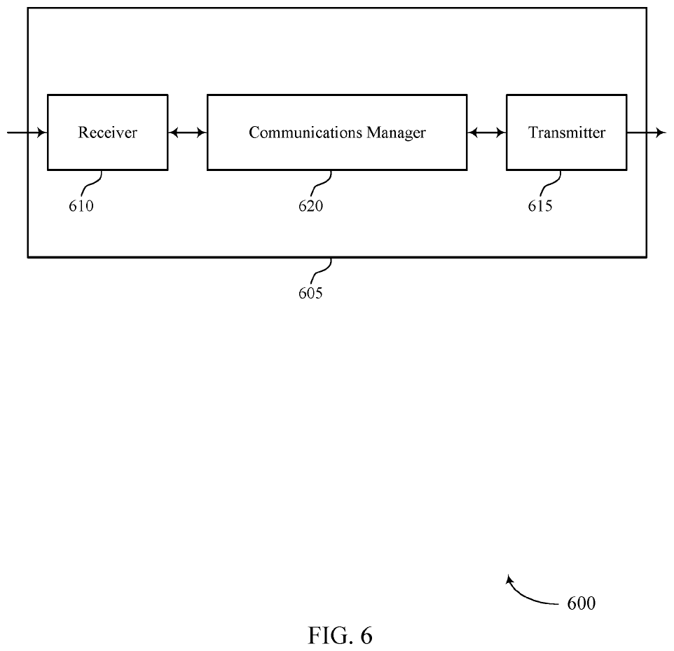

FIG. 6 shows a block diagram 600 of a device 605 that supports reconfigurable surface controller capability signaling in accordance with aspects of the present disclosure. The device 605 may be an example of aspects of a wireless device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to reconfigurable surface controller capability signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reconfigurable surface controller capability signaling). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of reconfigurable surface controller capability signaling as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first wireless device in accordance with examples as disclosed herein. For example, the communications manager 620 may be configured as or otherwise support a means for receiving, from a controller of a reconfigurable surface, an indication of a capability of the controller of the reconfigurable surface to perform one or more operations associated with communications between the controller and the first wireless device. The communications manager 620 may be configured as or otherwise support a means for communicating first information with the controller of the reconfigurable surface based on receiving the indication of the capability. The communications manager 620 may be configured as or otherwise support a means for communicating with a second wireless device via the reconfigurable surface, where an adjustment for the reconfigurable surface for the communicating with the second wireless device is based on the first information.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for the device 605 to perform communication operations with a controller of a reconfigurable surface that increase the efficiency of wireless communications. For instance, receiving the indication of the capability of the indication from the controller may enable the device 605 to identify that the controller is capable of performing a particular communications operation (e.g., decoding), where the communications operation may increase a range of communications or may be associated with a reduced latency.

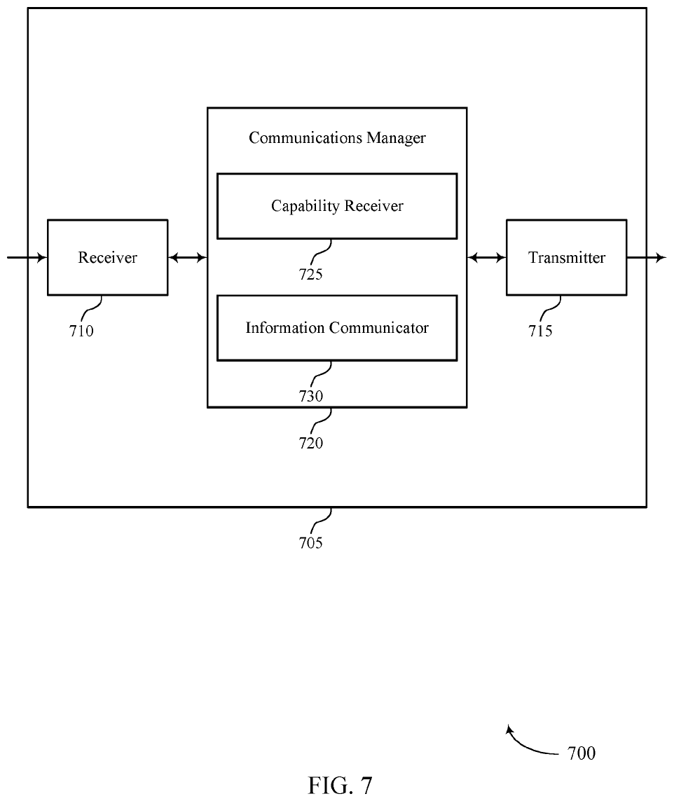

FIG. 7 shows a block diagram 700 of a device 705 that supports reconfigurable surface controller capability signaling in accordance with aspects of the present disclosure. The device 705 may be an example of aspects of a device 605 or a wireless device (e.g., a UE 115 or a base station 105) as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to reconfigurable surface controller capability signaling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reconfigurable surface controller capability signaling). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of reconfigurable surface controller capability signaling as described herein. For example, the communications manager 720 may include a capability receiver 725 an information communicator 730, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first wireless device in accordance with examples as disclosed herein. The capability receiver 725 may be configured as or otherwise support a means for receiving, from a controller of a reconfigurable surface, an indication of a capability of the controller of the reconfigurable surface to perform one or more operations associated with communications between the controller and the first wireless device. The information communicator 730 may be configured as or otherwise support a means for communicating first information with the controller of the reconfigurable surface based on receiving the indication of the capability. The information communicator 730 may be configured as or otherwise support a means for communicating with a second wireless device via the reconfigurable surface, where an adjustment for the reconfigurable surface for the communicating with the second wireless device is based on the first information.

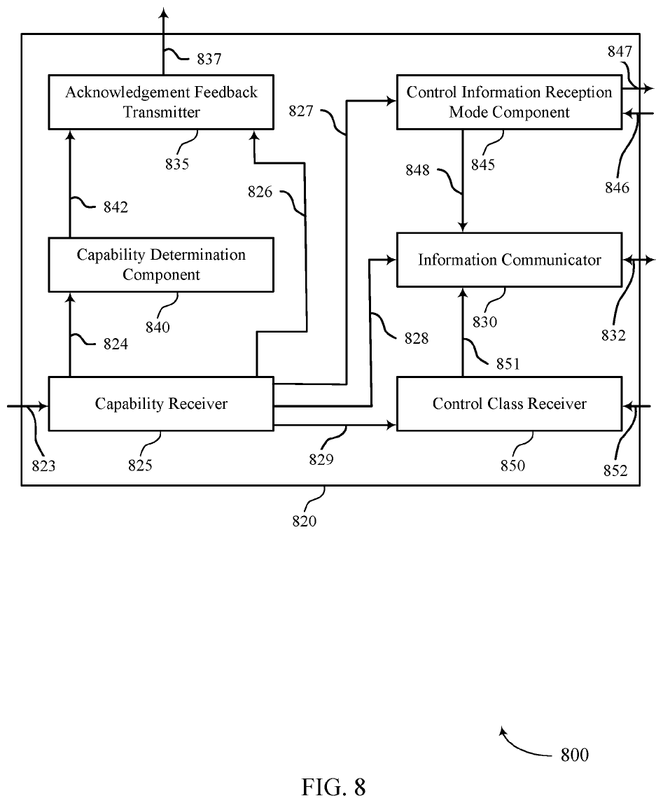

FIG. 8 shows a block diagram 800 of a communications manager 820 that supports reconfigurable surface controller capability signaling in accordance with aspects of the present disclosure. The communications manager 820 may be an example of aspects of a communications manager 620, a communications manager 720, or both, as described herein. The communications manager 820, or various components thereof, may be an example of means for performing various aspects of reconfigurable surface controller capability signaling as described herein. For example, the communications manager 820 may include a capability receiver 825, an information communicator 830, an acknowledgement feedback transmitter 835, a capability determination component 840, a control information reception mode component 845, a control class receiver 850, or any combination thereof. Each of these components may communicate, directly or indirectly, with one another (e.g., via one or more buses).

The communications manager 820 may support wireless communication at a first wireless device in accordance with examples as disclosed herein. The capability receiver 825 may be configured as or otherwise support a means for receiving, from a controller of a reconfigurable surface, an indication 823 of a capability of the controller of the reconfigurable surface to perform one or more operations associated with communications between the controller and the first wireless device. The information communicator 830 may be configured as or otherwise support a means for communicating first information 832 with the controller of the reconfigurable surface based on receiving the indication of the capability. In some examples, the information communicator 830 may be configured as or otherwise support a means for communicating with a second wireless device via the reconfigurable surface, where an adjustment for the reconfigurable surface for the communicating with the second wireless device is based on the first information. In some examples, capability receiver 825 may provide an indication 828 of the capability to information communicator 830.

In some examples, the indication 823 of the capability of the controller includes an indication that the controller is capable of decoding acknowledgement feedback for a wake-up signal, and the acknowledgement feedback transmitter 835 may be configured as or otherwise support a means for transmitting, to the controller of the reconfigurable surface, the acknowledgement feedback 837 for the wake-up signal based on receiving the indication 823 that the controller is capable of decoding the acknowledgement feedback for the wake-up signal. In some examples, capability receiver 825 may provide an indication 826 of the capability to acknowledgement feedback transmitter 835.

In some examples, the first wireless device is a first UE, and the capability determination component 840 may be configured as or otherwise support a means for determining that the controller of the reconfigurable surface lacks a capability to decode acknowledgement feedback for a wake-up signal. In some examples, the first wireless device is a first UE, and the acknowledgement feedback transmitter 835 may be configured as or otherwise support a means for transmitting the acknowledgement feedback 837 for the wake-up signal to a second UE for relay to a serving base station based on determining that the controller of the reconfigurable surface lacks the capability. In some examples, capability receiver may transmit an indication 824 of the capability to capability determination component 840 and capability determination component 840 may transmit an indication 842 that the reconfigurable surface lacks a capability to decode acknowledgement feedback to acknowledgement feedback transmitter 835.

In some examples, the control information reception mode component 845 may be configured as or otherwise support a means for transmitting, to the controller of the reconfigurable surface, an indication 847 of a control information reception mode for the controller, where communicating the first information is based on the indication of the capability indicating that the controller is configured for a first control information reception mode corresponding to monitoring one or more reception opportunities for the first information. In some examples, control information reception mode component 845 may indicate, to information communicator 830, an indication 848 of the channel information reception mode. In some examples, capability receiver 825 may indicate an indication 827 of the capability to control information reception mode component 845.

In some examples, the control information reception mode component 845 may be configured as or otherwise support a means for transmitting, to the controller of the reconfigurable surface, a set of multiple indications 847 of the control information reception mode for the controller, where each indication of the set of multiple indications 847 is associated with a time period.

In some examples, transmitting the indication 847 of the control information reception mode for the controller is based on a mobility of the first wireless device or the second wireless device, handover to the first wireless device or the second wireless device, or both.

In some examples, the control information reception mode component 845 may be configured as or otherwise support a means for receiving, from the controller of the reconfigurable surface, an indication 846 of a control information reception mode for the controller, where communicating the first information is based on receiving the indication 846 of the control information reception mode. In some examples, control information reception mode component 845 may transmit an indication 848 of the control information reception mode to information communicator 830.

In some examples, the control information reception mode component 845 may be configured as or otherwise support a means for receiving, from the controller of the reconfigurable surface, a set of multiple indications 846 of the control information reception mode for the controller, where each indication of the set of multiple indications 846 is associated with a respective component carrier.

In some examples, the control class receiver 850 may be configured as or otherwise support a means for receiving, from the controller of the reconfigurable surface, an indication 852 of a class of controllers to which the controller belongs, where communicating the first information with the controller is based on receiving the indication of the class of the controller. In some examples, control class receiver 850 may transmit an indication 851 of the class of controllers to information communicator 830. In some examples, capability receiver 825 may be configured to transmit an indication 829 of the capability to control class receiver 850.

In some examples, the first information includes a shared channel message indicating a set of beamforming weights. In some examples, the adjustment of the reconfigurable surface is based on the set of beamforming weights.

In some examples, the shared channel message includes a sidelink shared channel message indicating the set of beamforming weights, a sidelink control information message indicating the set of beamforming weights, a medium access control (MAC) control element message indicating the set of beamforming weights, or a downlink shared channel message indicating the set of beamforming weights.

In some examples, the indication of the capability includes an indication that the controller is capable of decoding or encoding downlink control information messages, uplink control information messages, sidelink shared channel messages, downlink shared channel messages, uplink shared channel messages, sidelink control channel messages, or any combination thereof.

In some examples, the indication of the capability includes an indication that the controller is capable of decoding or encoding a sequence-based non-coherent transmission, that the controller is capable of performing polar decoding or polar encoding, that the controller is capable of performing low-density parity check decoding or low-density parity check encoding, or any combination thereof.

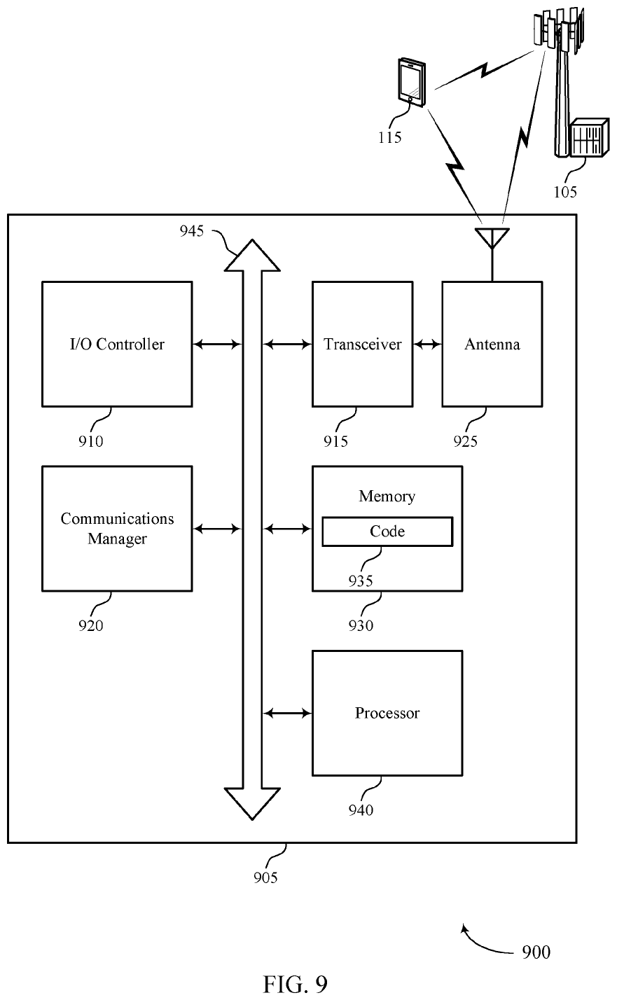

FIG. 9 shows a diagram of a system 900 including a device 905 that supports reconfigurable surface controller capability signaling in accordance with aspects of the present disclosure. The device 905 may be an example of or include the components of a device 605, a device 705, or a wireless device as described herein. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random-access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic input/output system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting reconfigurable surface controller capability signaling). For example, the device 905 or a component of the device 905 may include a processor 940 and memory 930 coupled to the processor 940, the processor 940 and memory 930 configured to perform various functions described herein.

The communications manager 920 may support wireless communication at a first wireless device in accordance with examples as disclosed herein. For example, the communications manager 920 may be configured as or otherwise support a means for receiving, from a controller of a reconfigurable surface, an indication of a capability of the controller of the reconfigurable surface to perform one or more operations associated with communications between the controller and the first wireless device. The communications manager 920 may be configured as or otherwise support a means for communicating first information with the controller of the reconfigurable surface based on receiving the indication of the capability. The communications manager 920 may be configured as or otherwise support a means for communicating with a second wireless device via the reconfigurable surface, where an adjustment for the reconfigurable surface for the communicating with the second wireless device is based on the first information.

By including or configuring the communications manager 920 in accordance with examples as described herein, the device 905 may support techniques for device 905 to perform communication operations with a controller of a reconfigurable surface that increase the efficiency of wireless communications. For instance, receiving the indication of the capability of the indication from the controller may enable the device 905 to identify that the controller is capable of performing a particular communications operation (e.g., decoding), where the communications operation may increase a range of communications or may be associated with a reduced latency.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of reconfigurable surface controller capability signaling as described herein, or the processor 940 and the memory 930 may be otherwise configured to perform or support such operations.

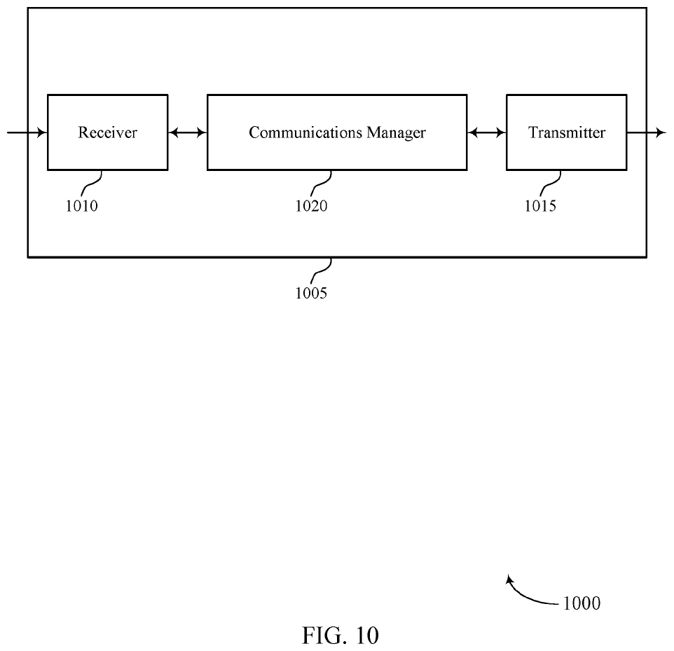

FIG. 10 shows a block diagram 1000 of a device 1005 that supports reconfigurable surface controller capability signaling in accordance with aspects of the present disclosure. The device 1005 may be an example of aspects of a controller of a reconfigurable surface as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to reconfigurable surface controller capability signaling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to reconfigurable surface controller capability signaling). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of reconfigurable surface controller capability signaling as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a controller of a reconfigurable surface in accordance with examples as disclosed herein. For example, the communications manager 1020 may be configured as or otherwise support a means for transmitting, to a first wireless device, an indication of a capability of the controller of the reconfigurable surface to perform one or more operations associated with communication between the controller and the first wireless device. The communications manager 1020 may be configured as or otherwise support a means for communicating first information with the first wireless device based on transmitting the indication of the capability. The communications manager 1020 may be configured as or otherwise support a means for adjusting the reconfigurable surface for communications between the first wireless device and a second wireless device based on the first information.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for device 1005 to perform communication operations with a controller of a reconfigurable surface that increase the efficiency of wireless communications. For instance, transmitting the indication of the capability of the indication to a UE may enable the UE to identify that the controller is capable of performing a particular communications operation (e.g., decoding), where the communications operation may increase a range of communications or may be associated with a reduced latency as compared to other operations.

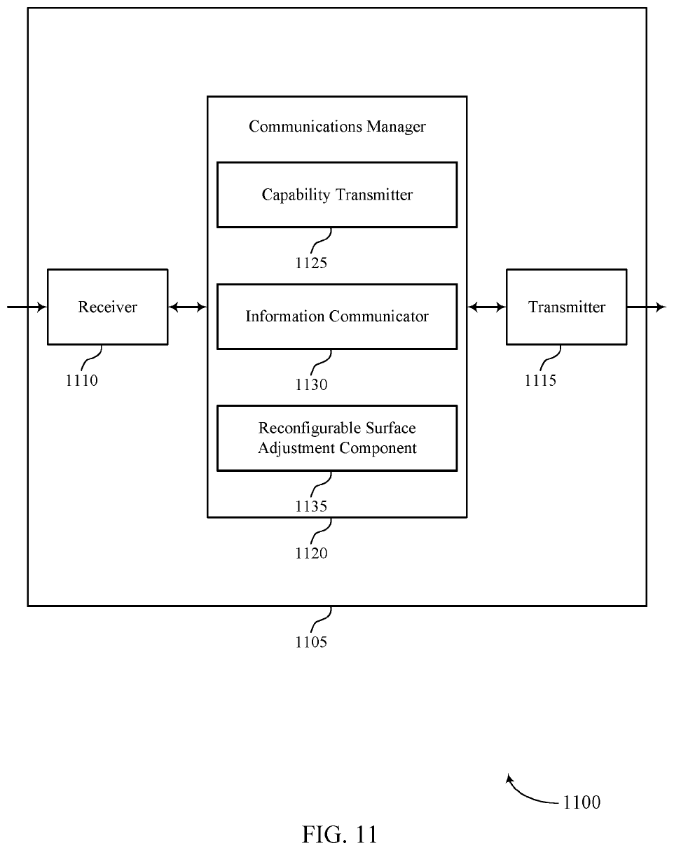

FIG. 11 shows a block diagram 1100 of a device 1105 that supports reconfigurable surface controller capability signaling in accordance with aspects of the present disclosure. The device 1105 may be an example of aspects of a device 1005 or a controller 205 of a reconfigurable surface 210 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to reconfigurable surface controller capability signaling). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to reconfigurable surface controller capability signaling). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of reconfigurable surface controller capability signaling as described herein. For example, the communications manager 1120 may include a capability transmitter 1125, an information communicator 1130, a reconfigurable surface adjustment component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a controller of a reconfigurable surface in accordance with examples as disclosed herein. The capability transmitter 1125 may be configured as or otherwise support a means for transmitting, to a first wireless device, an indication of a capability of the controller of the reconfigurable surface to perform one or more operations associated with communication between the controller and the first wireless device. The information communicator 1130 may be configured as or otherwise support a means for communicating first information with the first wireless device based on transmitting the indication of the capability. The reconfigurable surface adjustment component 1135 may be configured as or otherwise support a means for adjusting the reconfigurable surface for communications between the first wireless device and a second wireless device based on the first information.

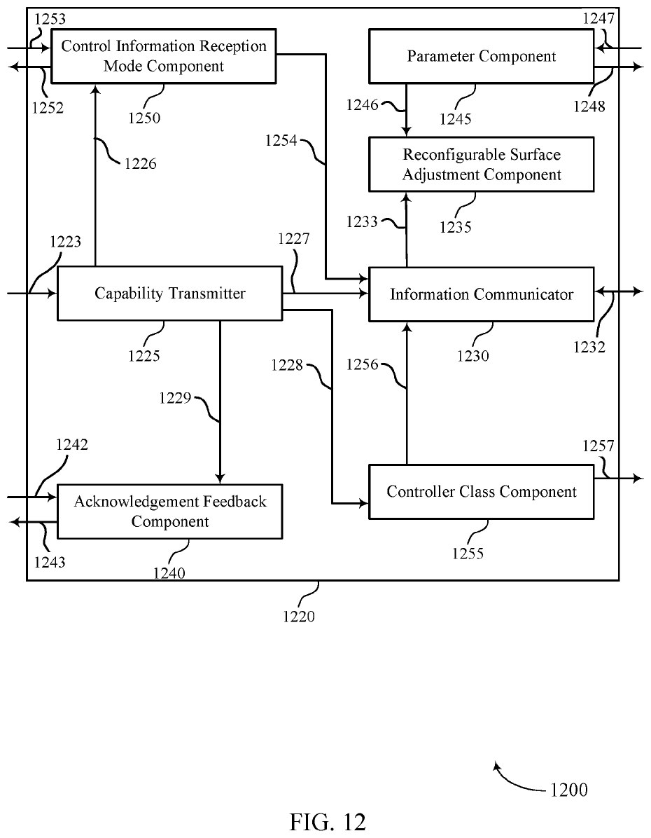

FIG. 12 shows a block diagram 1200 of a communications manager 1220 that supports reconfigurable surface controller capability signaling in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of reconfigurable surface controller capability signaling as described herein. For example, the communications manager 1220 may include a capability transmitter 1225, an information communicator 1230, a reconfigurable surface adjustment component 1235, an acknowledgement feedback component 1240, a parameter component 1245, a control information reception mode component 1250, a controller class component 1255, or any combination thereof. Each of these components may communicate, directly or indirectly, with one another (e.g., via one or more buses).

The communications manager 1220 may support wireless communication at a controller of a reconfigurable surface in accordance with examples as disclosed herein. The capability transmitter 1225 may be configured as or otherwise support a means for transmitting, to a first wireless device, an indication 1223 of a capability of the controller of the reconfigurable surface to perform one or more operations associated with communication between the controller and the first wireless device. The information communicator 1230 may be configured as or otherwise support a means for communicating first information 1232 with the first wireless device based on transmitting the indication of the capability. In some examples, capability transmitter 1225 may transmit an indication 1227 of the capability to information communicator 1230. The reconfigurable surface adjustment component 1235 may be configured as or otherwise support a means for adjusting the reconfigurable surface for communications between the first wireless device and a second wireless device based on the first information. In some examples, information communicator 1230 may transmit an indication 1233 of the first information to reconfigurable surface adjustment component 1235.

In some examples, the indication 1223 of the capability of the controller includes an indication that the controller is capable of decoding acknowledgement feedback for a wake-up signal, and the acknowledgement feedback component 1240 may be configured as or otherwise support a means for receiving, from the first wireless device, the acknowledgement feedback 1242 for the wake-up signal based on transmitting the indication 1223 that the controller is capable of decoding the acknowledgement feedback for the wake-up signal. In some examples, capability transmitter 1225 may be configured to transmit an indication 1229 of the capability to acknowledgement feedback component 1240.

In some examples, the acknowledgement feedback component 1240 may be configured as or otherwise support a means for transmitting the acknowledgement feedback 1243 for the wake-up signal to the second wireless device based on receiving the acknowledgement feedback 1242 for the wake-up signal from the first wireless device.

In some examples, the parameter component 1245 may be configured as or otherwise support a means for receiving, from the second wireless device, an indication of a location 1247 of the first wireless device. In some examples, the reconfigurable surface adjustment component 1235 may be configured as or otherwise support a means for adjusting the reconfigurable surface to redirect a wake-up signal from the second wireless device to the first wireless device based on receiving the indication 1247 of the location of the first wireless device. In some examples, parameter component 1245 may transmit an indication 1246 of the location to reconfigurable surface adjustment component 1235.

In some examples, the location of the first wireless device includes an angle associated with the first wireless device, a distance associated with the first wireless device, or both.

In some examples, the parameter component 1245 may be configured as or otherwise support a means for transmitting, to the second wireless device, an indication 1248 of a number of repetitions corresponding to a set of resources. In some examples, the reconfigurable surface adjustment component 1235 may be configured as or otherwise support a means for adjusting the reconfigurable surface to redirect, over each resource of the set of resources, a respective wake-up signal over a respective beam based on transmitting the indication 1248 of the number of repetitions. In some examples, parameter component 1245 may transmit an indication 1246 of the number of repetitions to reconfigurable surface adjustment component 1235.

In some examples, the parameter component 1245 may be configured as or otherwise support a means for receiving, from the second wireless device and for each beam of a set of beams, an indication 1247 of an angle direction, an indication 1247 of a number of repetitions, an indication 1247 of a set of beamforming weights, or any combination thereof. In some examples, the reconfigurable surface adjustment component 1235 may be configured as or otherwise support a means for adjusting the reconfigurable surface to redirect, for each beam of the set of beams, a respective wake-up signal based on the indication 1247 of the angle direction, the indication 1247 of the number of repetitions, the indication 1247 of the set of beamforming weights, or any combination thereof. In some examples, parameter component 1245 may transmit an indication 1246 of the angle direction, the number of repetitions, the set of beamforming weights, or any combination thereof to reconfigurable surface adjustment component 1235.

In some examples, the control information reception mode component 1250 may be configured as or otherwise support a means for receiving, from the first wireless device, an indication 1252 of a control information reception mode for the controller, where communicating the first information is based on the indication of the control information reception mode indicating a first control information reception mode corresponding to monitoring one or more reception opportunities for the first information. In some examples, control information reception mode component 1250 may transmit an indication 1254 of the control information reception mode to information communicator 1230. In some examples, capability transmitter 1225 may transmit an indication 1226 of the capability to control information reception mode component 1250.

In some examples, the control information reception mode component 1250 may be configured as or otherwise support a means for receiving, from the first wireless device, a set of multiple indications 1252 of the control information reception mode for the controller, where each indication of indications is associated with a time period.

In some examples, the control information reception mode component 1250 may be configured as or otherwise support a means for transmitting, to the first wireless device, an indication 1253 of a control information reception mode for the controller, where communicating the first information is based on transmitting the indication of the control information reception mode. In some examples, control information reception mode component 1250 may transmit an indication 1254 of the control information reception mode to information communicator 1230.

In some examples, the control information reception mode component 1250 may be configured as or otherwise support a means for transmitting, to the first wireless device, a set of multiple indications 1253 of the control information reception mode for the controller, where each indication of the set of multiple indications 1253 is associated with a respective component carrier.

In some examples, the control information reception mode component 1250 may be configured as or otherwise support a means for transmitting, to the first wireless device, an indication 1253 of a control information reception mode for the controller, where communicating the first information is based on transmitting the indication 1253 of the control information reception mode.

In some examples, the controller class component 1255 may be configured as or otherwise support a means for transmitting, to the first wireless device, an indication 1257 of a class of controllers to which the controller belongs, where communicating the first information with the first wireless device is based on transmitting the indication 1257 of the class of controllers to which the controller belongs. In some examples, controller class component 1255 may transmit an indication 1256 of the controller class to information communicator 1230. In some examples, capability transmitter 1225 may transmit an indication 1228 of the capability to controller class component 1255.

In some examples, the first information includes a shared channel transmission indicating a set of beamforming weights. In some examples, the adjustment of the reconfigurable surface is based on the set of beamforming weights.

In some examples, the shared channel transmission includes a sidelink shared channel transmission indicating the set of beamforming weights, second stage sidelink control information indicating the set of beamforming weights, a medium access control (MAC) control element transmission indicating the set of beamforming weights, or a downlink shared channel transmission indicating the set of beamforming weights.

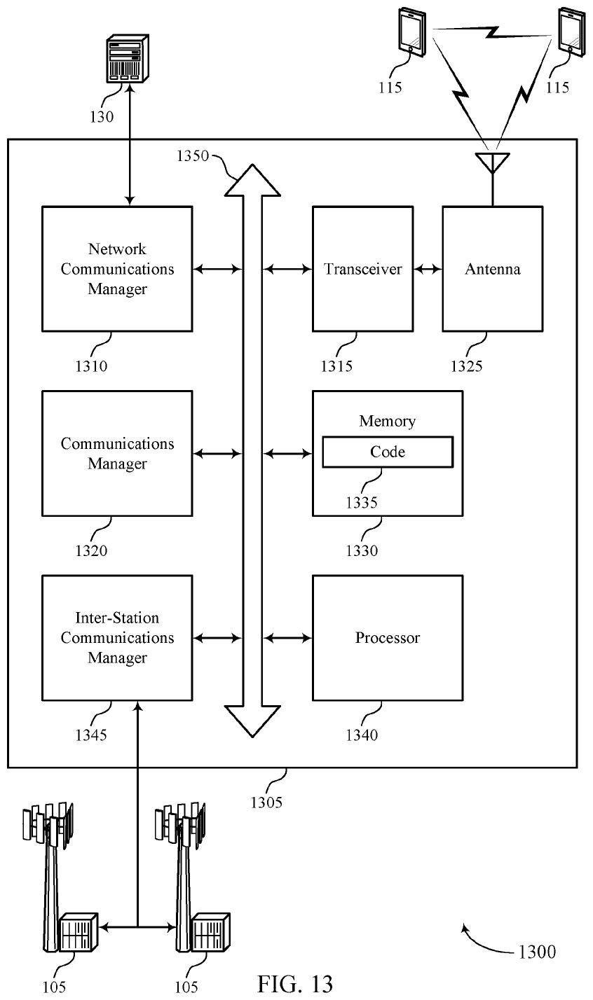

FIG. 13 shows a diagram of a system 1300 including a device 1305 that supports reconfigurable surface controller capability signaling in accordance with aspects of the present disclosure. The device 1305 may be an example of or include the components of a device 1005, a device 1105, or a controller of a reconfigurable surface as described herein. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting reconfigurable surface controller capability signaling). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a controller of a reconfigurable surface in accordance with examples as disclosed herein. For example, the communications manager 1320 may be configured as or otherwise support a means for transmitting, to a first wireless device, an indication of a capability of the controller of the reconfigurable surface to perform one or more operations associated with communication between the controller and the first wireless device. The communications manager 1320 may be configured as or otherwise support a means for communicating first information with the first wireless device based on transmitting the indication of the capability. The communications manager 1320 may be configured as or otherwise support a means for adjusting the reconfigurable surface for communications between the first wireless device and a second wireless device based on the first information.

By including or configuring the communications manager 1320 in accordance with examples as described herein, the device 1305 may support techniques for device 1005 to perform communication operations with a controller of a reconfigurable surface that increase the efficiency of wireless communications. For instance, transmitting the indication of the capability of the indication to a UE may enable the UE to identify that the controller is capable of performing a particular communications operation (e.g., decoding), where the communications operation may increase a range of communications or may be associated with a reduced latency as compared to other operations.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of reconfigurable surface controller capability signaling as described herein, or the processor 1340 and the memory 1330 may be otherwise configured to perform or support such operations.

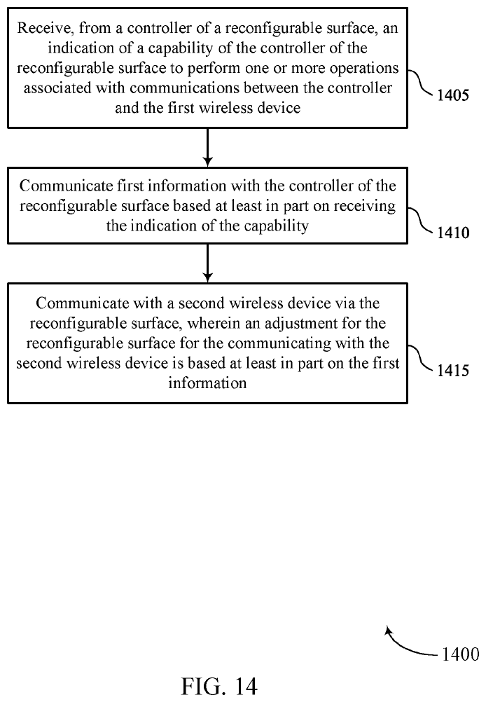

FIG. 14 shows a flowchart illustrating a method 1400 that supports reconfigurable surface controller capability signaling in accordance with aspects of the present disclosure. The operations of the method 1400 may be implemented by a wireless device or its components as described herein. For example, the operations of the method 1400 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1405, the method may include receiving, from a controller of a reconfigurable surface, an indication of a capability of the controller of the reconfigurable surface to perform one or more operations associated with communications between the controller and the first wireless device. Receiving the indication of the capability may include identifying time-frequency resources over which the indication of the capability is to be received and receiving the indication of the capability over the time-frequency resources. The operations of 1405 may be performed in accordance with examples as disclosed herein. In some examples, aspects of the operations of 1405 may be performed by a capability receiver 825 as described with reference to FIG. 8.

At 1410, the method may include communicating first information with the controller of the reconfigurable surface based on receiving the indication of the capability. Communicating the first information may include identifying time-frequency resources over which the first information is to be communicated and communicating the first information over the time-frequency resources. The operations of 1410 may be performed in accordance with examples as disclosed herein. In some examples, aspects of the operations of 1410 may be performed by an information communicator 830 as described with reference to FIG. 8.

At 1415, the method may include communicating with a second wireless device via the reconfigurable surface, where an adjustment for the reconfigurable surface for the communicating with the second wireless device is based on the first information. Communicating with the second wireless device may include identifying time-frequency resources over which communications is to occur and communicating a transmission with the second wireless device over the time-frequency resources. The operations of 1415 may be performed in accordance with examples as disclosed herein. In some examples, aspects of the operations of 1415 may be performed by an information communicator 830 as described with reference to FIG. 8.

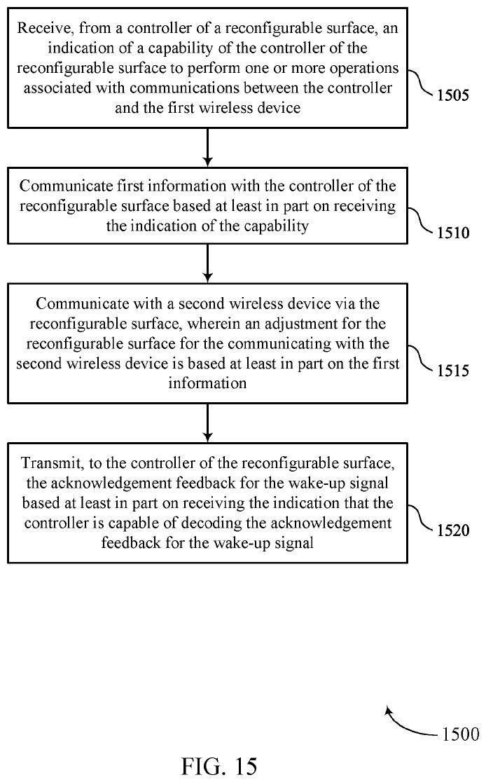

FIG. 15 shows a flowchart illustrating a method 1500 that supports reconfigurable surface controller capability signaling in accordance with aspects of the present disclosure. The operations of the method 1500 may be implemented by a wireless device or its components as described herein. For example, the operations of the method 1500 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1505, the method may include receiving, from a controller of a reconfigurable surface, an indication of a capability of the controller of the reconfigurable surface to perform one or more operations associated with communications between the controller and the first wireless device. Receiving the indication of the capability may include identifying time-frequency resources over which the indication of the capability is to be received and receiving the indication of the capability over the time-frequency resources. The operations of 1505 may be performed in accordance with examples as disclosed herein. In some examples, aspects of the operations of 1505 may be performed by a capability receiver 825 as described with reference to FIG. 8.

At 1510, the method may include communicating first information with the controller of the reconfigurable surface based on receiving the indication of the capability. Communicating the first information may include identifying time-frequency resources over which the first information is to be communicated and communicating the first information over the time-frequency resources. The operations of 1510 may be performed in accordance with examples as disclosed herein. In some examples, aspects of the operations of 1510 may be performed by an information communicator 830 as described with reference to FIG. 8.

At 1515, the method may include communicating with a second wireless device via the reconfigurable surface, where an adjustment for the reconfigurable surface for the communicating with the second wireless device is based on the first information. Communicating with the second wireless device may include identifying time-frequency resources over which communications is to occur and communicating a transmission with the second wireless device over the time-frequency resources. The operations of 1515 may be performed in accordance with examples as disclosed herein. In some examples, aspects of the operations of 1515 may be performed by an information communicator 830 as described with reference to FIG. 8.

At 1520, the method may include transmitting, to the controller of the reconfigurable surface, the acknowledgement feedback for the wake-up signal based on receiving the indication that the controller is capable of decoding the acknowledgement feedback for the wake-up signal. Transmitting the acknowledgement feedback may include identifying time-frequency resources over which the acknowledgement feedback is to be transmitted and transmitting the acknowledgement feedback over the time-frequency resources. The operations of 1520 may be performed in accordance with examples as disclosed herein. In some examples, aspects of the operations of 1520 may be performed by an acknowledgement feedback transmitter 835 as described with reference to FIG. 8.

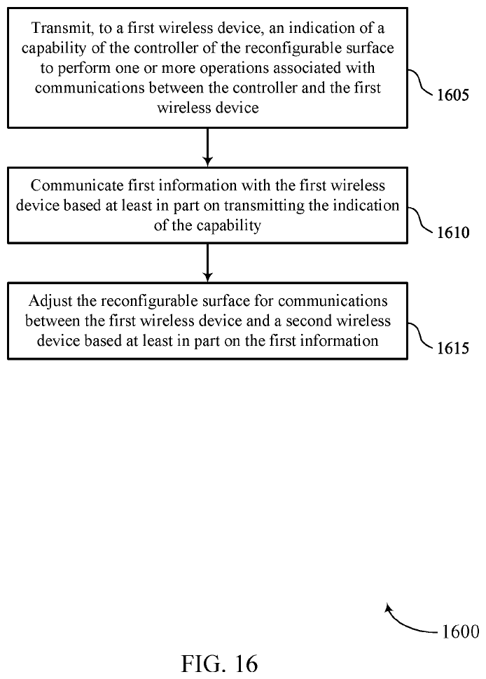

FIG. 16 shows a flowchart illustrating a method 1600 that supports reconfigurable surface controller capability signaling in accordance with aspects of the present disclosure. The operations of the method 1600 may be implemented by a controller of a reconfigurable surface or its components as described herein. For example, the operations of the method 1600 may be performed by a controller of a reconfigurable surface as described with reference to FIGS. 1 through 5 and 10 through 13. In some examples, a controller of a reconfigurable surface may execute a set of instructions to control the functional elements of the controller of a reconfigurable surface to perform the described functions. Additionally, or alternatively, the controller of a reconfigurable surface may perform aspects of the described functions using special-purpose hardware.

At 1605, the method may include transmitting, to a first wireless device, an indication of a capability of the controller of the reconfigurable surface to perform one or more operations associated with communication between the controller and the first wireless device. Transmitting the indication of the capability may include identifying time-frequency resources over which the indication of the capability is to be transmitted and transmitting the indication of the capability over the time-frequency resources. The operations of 1605 may be performed in accordance with examples as disclosed herein. In some examples, aspects of the operations of 1605 may be performed by a capability transmitter 1225 as described with reference to FIG. 12.

At 1610, the method may include communicating first information with the first wireless device based on transmitting the indication of the capability. The operations of 1610 may be performed in accordance with examples as disclosed herein. Communicating the first information may include identifying time-frequency resources over which the first information is to be communicated and communicating the first information over the time-frequency resources. In some examples, aspects of the operations of 1610 may be performed by an information communicator 1230 as described with reference to FIG. 12.

At 1615, the method may include adjusting the reconfigurable surface for communications between the first wireless device and a second wireless device based on the first information. Adjusting the reconfigurable surface may include identifying one or more elements of the reconfigurable surface and adjusting a parameter (e.g., an amount of scattering, absorption, reflection, and diffraction) associated with the one or more elements. The operations of 1615 may be performed in accordance with examples as disclosed herein. In some examples, aspects of the operations of 1615 may be performed by a reconfigurable surface adjustment component 1235 as described with reference to FIG. 12.

The following provides an overview of aspects of the present disclosure:

Aspect 1: A method for wireless communication at a first wireless device, comprising: receiving, from a controller of a reconfigurable surface, an indication of a capability of the controller of the reconfigurable surface to perform one or more operations associated with communications between the controller and the first wireless device; communicating first information with the controller of the reconfigurable surface based at least in part on receiving the indication of the capability; and communicating with a second wireless device via the reconfigurable surface, wherein an adjustment for the reconfigurable surface for the communicating with the second wireless device is based at least in part on the first information.

Aspect 2: The method of aspect 1, wherein the indication of the capability of the controller comprises an indication that the controller is capable of decoding acknowledgement feedback for a wake-up signal, the method further comprising: transmitting, to the controller of the reconfigurable surface, the acknowledgement feedback for the wake-up signal based at least in part on receiving the indication that the controller is capable of decoding the acknowledgement feedback for the wake-up signal.

Aspect 3: The method of any of aspects 1 through 2, wherein the first wireless device is a first UE, and wherein the method further comprises: determining that the controller of the reconfigurable surface lacks a capability to decode acknowledgement feedback for a wake-up signal; and transmitting the acknowledgement feedback for the wake-up signal to a second UE for relay to a serving base station based at least in part on determining that the controller of the reconfigurable surface lacks the capability.

Aspect 4: The method of any of aspects 1 through 3, further comprising: transmitting, to the controller of the reconfigurable surface, an indication of a control information reception mode for the controller, wherein communicating the first information is based at least in part on the indication of the capability indicating that the controller is configured for a first control information reception mode corresponding to monitoring one or more reception opportunities for the first information.

Aspect 5: The method of aspect 4, further comprising: transmitting, to the controller of the reconfigurable surface, a plurality of indications of the control information reception mode for the controller, wherein each indication of the plurality of indications is associated with a time period.

Aspect 6: The method of any of aspects 4 through 5, wherein transmitting the indication of the control information reception mode for the controller is based at least in part on a mobility of the first wireless device or the second wireless device, handover to the first wireless device or the second wireless device, or both.

Aspect 7: The method of any of aspects 1 through 6, further comprising: receiving, from the controller of the reconfigurable surface, an indication of a control information reception mode for the controller, wherein communicating the first information is based at least in part on receiving the indication of the control information reception mode.

Aspect 8: The method of aspect 7, further comprising: receiving, from the controller of the reconfigurable surface, a plurality of indications of the control information reception mode for the controller, wherein each indication of the plurality of indications is associated with a respective component carrier.

Aspect 9: The method of any of aspects 1 through 8, further comprising: receiving, from the controller of the reconfigurable surface, an indication of a class of controllers to which the controller belongs, wherein communicating the first information with the controller is based at least in part on receiving the indication of the class of controllers to which the controller belongs.

Aspect 10: The method of any of aspects 1 through 9, wherein, the first information comprises a shared channel message indicating a set of beamforming weights, and the adjustment of the reconfigurable surface is based at least in part on the set of beamforming weights

Aspect 11: The method of aspect 10, wherein the shared channel message comprises a sidelink shared channel message indicating the set of beamforming weights, a sidelink control information message indicating the set of beamforming weights, a medium access control (MAC) control element message indicating the set of beamforming weights, or a downlink shared channel message indicating the set of beamforming weights.

Aspect 12: The method of any of aspects 1 through 11, wherein the indication of the capability comprises an indication that the controller is capable of decoding or encoding downlink control information messages, uplink control information messages, sidelink shared channel messages, downlink shared channel messages, uplink shared channel messages, sidelink control channel messages, or any combination thereof.

Aspect 13: The method of any of aspects 1 through 12, wherein the indication of the capability comprises an indication that the controller is capable of decoding or encoding a sequence-based non-coherent transmission, that the controller is capable of performing polar decoding or polar encoding, that the controller is capable of performing low-density parity check decoding or low-density parity check encoding, or any combination thereof.

Aspect 14: A method for wireless communication at a controller of a reconfigurable surface, comprising: transmitting, to a first wireless device, an indication of a capability of the controller of the reconfigurable surface to perform one or more operations associated with communications between the controller and the first wireless device; communicating first information with the first wireless device based at least in part on transmitting the indication of the capability; and adjusting the reconfigurable surface for communications between the first wireless device and a second wireless device based at least in part on the first information.

Aspect 15: The method of aspect 14, wherein the indication of the capability of the controller comprises an indication that the controller is capable of decoding acknowledgement feedback for a wake-up signal, the method further comprising: receiving, from the first wireless device, the acknowledgement feedback for the wake-up signal based at least in part on transmitting the indication that the controller is capable of decoding the acknowledgement feedback for the wake-up signal.

Aspect 16: The method of aspect 15, further comprising: transmitting the acknowledgement feedback for the wake-up signal to the second wireless device based at least in part on receiving the acknowledgement feedback for the wake-up signal from the first wireless device.

Aspect 17: The method of any of aspects 14 through 16, further comprising: receiving, from the second wireless device, an indication of a location of the first wireless device; and adjusting the reconfigurable surface to redirect a wake-up signal from the second wireless device to the first wireless device based at least in part on receiving the indication of the location of the first wireless device.

Aspect 18: The method of aspect 17, wherein the location of the first wireless device comprises an angle associated with the first wireless device, a distance associated with the first wireless device, or both.

Aspect 19: The method of any of aspects 14 through 18, further comprising: transmitting, to the second wireless device, an indication of a number of repetitions corresponding to a set of resources; and adjusting the reconfigurable surface to redirect, over each resource of the set of resources, a respective wake-up signal over a respective beam based at least in part on transmitting the indication of the number of repetitions.

Aspect 20: The method of any of aspects 14 through 19, further comprising: receiving, from the second wireless device and for each beam of a set of beams, an indication of an angle direction, an indication of a number of repetitions, an indication of a set of beamforming weights, or any combination thereof; and adjusting the reconfigurable surface to redirect, for each beam of the set of beams, a respective wake-up signal based at least in part on the indication of the angle direction, the indication of the number of repetitions, the indication of the set of beamforming weights, or any combination thereof.

Aspect 21: The method of any of aspects 14 through 20, further comprising: receiving, from the first wireless device, an indication of a control information reception mode for the controller, wherein communicating the first information is based at least in part on the indication of the control information reception mode indicating a first control information reception mode corresponding to monitoring one or more reception opportunities for the first information.

Aspect 22: The method of aspect 21, further comprising: receiving, from the first wireless device, a plurality of indications of the control information reception mode for the controller, wherein each indication of indications is associated with a time period.

Aspect 23: The method of any of aspects 14 through 22, further comprising: transmitting, to the first wireless device, an indication of a control information reception mode for the controller, wherein communicating the first information is based at least in part on transmitting the indication of the control information reception mode.

Aspect 24: The method of aspect 23, further comprising: transmitting, to the first wireless device, a plurality of indications of the control information reception mode for the controller, wherein each indication of the plurality of indications is associated with a respective component carrier.

Aspect 25: The method of any of aspects 14 through 24, further comprising:

transmitting, to the first wireless device, an indication of a control information reception mode for the controller, wherein communicating the first information is based at least in part on transmitting the indication of the control information reception mode.

Aspect 26: The method of any of aspects 14 through 25, further comprising:

transmitting, to the first wireless device, an indication of a class of controllers to which the controller belongs, wherein communicating the first information with the first wireless device is based at least in part on transmitting the indication of the class of controllers to which the controller belongs.

Aspect 27: The method of any of aspects 14 through 26, wherein, the first information comprises a shared channel transmission indicating a set of beamforming weights, and the adjustment of the reconfigurable surface is based at least in part on the set of beamforming weights

Aspect 28: An apparatus for wireless communication at a first wireless device, comprising a processor; memory coupled with the processor; and instructions stored in the memory and executable by the processor to cause the apparatus to perform a method of any of aspects 1 through 13.

Aspect 29: An apparatus for wireless communication at a first wireless device, comprising at least one means for performing a method of any of aspects 1 through 13.

Aspect 30: A non-transitory computer-readable medium storing code for wireless communication at a first wireless device, the code comprising instructions executable by a processor to perform a method of any of aspects 1 through 13.

Aspect 31: An apparatus for wireless communication at a controller of a reconfigurable surface, comprising a processor; memory coupled with the processor; and instructions stored in the memory and executable by the processor to cause the apparatus to perform a method of any of aspects 14 through 27.

Aspect 32: An apparatus for wireless communication at a controller of a reconfigurable surface, comprising at least one means for performing a method of any of aspects 14 through 27.

Aspect 33: A non-transitory computer-readable medium storing code for wireless communication at a controller of a reconfigurable surface, the code comprising instructions executable by a processor to perform a method of any of aspects 14 through 27

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless device, comprising:
receiving, from a controller of a reconfigurable surface, an indication of a capability of the controller of the reconfigurable surface to perform one or more operations associated with communications between the controller and the first wireless device:
communicating first information with the controller of the reconfigurable surface based at least in part on receiving the indication of the capability; and
communicating with a second wireless device via the reconfigurable surface, wherein an adjustment for the reconfigurable surface for the communicating with the second wireless device is based at least in part on the first information.

2. The method of claim 1, wherein the indication of the capability of the controller comprises an indication that the controller is capable of decoding acknowledgement feedback for a wake-up signal, the method further comprising:
transmitting, to the controller of the reconfigurable surface, the acknowledgement feedback for the wake-up signal based at least in part on receiving the indication that the controller is capable of decoding the acknowledgement feedback for the wake-up signal.

3. The method of claim 1, wherein the first wireless device is a first user equipment (UE), and wherein the method further comprises:
determining that the controller of the reconfigurable surface lacks a capability to decode acknowledgement feedback for a wake-up signal; and
transmitting the acknowledgement feedback for the wake-up signal to a second UE for relay to a serving base station based at least in part on determining that the controller of the reconfigurable surface lacks the capability.

4. The method of claim 1, further comprising:
transmitting, to the controller of the reconfigurable surface, an indication of a control information reception mode for the controller, wherein communicating the first information is based at least in part on the indication of the capability indicating that the controller is configured for a first control information reception mode corresponding to monitoring one or more reception opportunities for the first information.

5. The method of claim 4, further comprising:
transmitting, to the controller of the reconfigurable surface, a plurality of indications of the control information reception mode for the controller, wherein each indication of the plurality of indications is associated with a time period.

6. The method of claim 4, wherein transmitting the indication of the control information reception mode for the controller is based at least in part on a mobility of the first wireless device or the second wireless device, handover to the first wireless device or the second wireless device, or both.

7. The method of claim 1, further comprising:
receiving, from the controller of the reconfigurable surface, an indication of a control information reception mode for the controller, wherein communicating the first information is based at least in part on receiving the indication of the control information reception mode.

8. The method of claim 7, further comprising:
receiving, from the controller of the reconfigurable surface, a plurality of indications of the control information reception mode for the controller, wherein each indication of the plurality of indications is associated with a respective component carrier.

9. The method of claim 1, further comprising:
receiving, from the controller of the reconfigurable surface, an indication of a class of controllers to which the controller belongs, wherein communicating the first information with the controller is based at least in part on receiving the indication of the class of controllers to which the controller belongs.

10. The method of claim 1, wherein
the first information comprises a shared channel message indicating a set of beamforming weights, and
the adjustment of the reconfigurable surface is based at least in part on the set of beamforming weights.

11. The method of claim 10, wherein the shared channel message comprises a sidelink shared channel message indicating the set of beamforming weights, a sidelink control information message indicating the set of beamforming weights, a medium access control (MAC) control element message indicating the set of beamforming weights, or a downlink shared channel message indicating the set of beamforming weights.

12. The method of claim 1, wherein the indication of the capability comprises an indication that the controller is capable of decoding or encoding downlink control information messages, uplink control information messages, sidelink shared channel messages, downlink shared channel messages, uplink shared channel messages, sidelink control channel messages, or any combination thereof.

13. The method of claim 1, wherein the indication of the capability comprises an indication that the controller is capable of decoding or encoding a sequence-based non-coherent transmission, that the controller is capable of performing polar decoding or polar encoding, that the controller is capable of performing low-density parity check decoding or low-density parity check encoding, or any combination thereof.

14. A method for wireless communication at a controller of a reconfigurable surface, comprising:
transmitting, to a first wireless device, an indication of a capability of the controller of the reconfigurable surface to perform one or more operations associated with communications between the controller and the first wireless device;
communicating first information with the first wireless device based at least in part on transmitting the indication of the capability; and
adjusting the reconfigurable surface for communications between the first wireless device and a second wireless device based at least in part on the first information.

15. The method of claim 14, wherein the indication of the capability of the controller comprises an indication that the controller is capable of decoding acknowledgement feedback for a wake-up signal, the method further comprising:
receiving, from the first wireless device, the acknowledgement feedback for the wake-up signal based at least in part on transmitting the indication that the controller is capable of decoding the acknowledgement feedback for the wake-up signal.

16. The method of claim 15, further comprising:
transmitting the acknowledgement feedback for the wake-up signal to the second wireless device based at least in part on receiving the acknowledgement feedback for the wake-up signal from the first wireless device.

17. The method of claim 14, further comprising:
receiving, from the second wireless device, an indication of a location of the first wireless device; and
adjusting the reconfigurable surface to redirect a wake-up signal from the second wireless device to the first wireless device based at least in part on receiving the indication of the location of the first wireless device.

18. The method of claim 17, wherein the location of the first wireless device comprises an angle associated with the first wireless device, a distance associated with the first wireless device, or both.

19. The method of claim 14, further comprising:
transmitting, to the second wireless device, an indication of a number of repetitions corresponding to a set of resources; and
adjusting the reconfigurable surface to redirect, over each resource of the set of resources, a respective wake-up signal over a respective beam based at least in part on transmitting the indication of the number of repetitions.

20. The method of claim 14, further comprising:
receiving, from the second wireless device and for each beam of a set of beams, an indication of an angle direction, an indication of a number of repetitions, an indication of a set of beamforming weights, or any combination thereof; and
adjusting the reconfigurable surface to redirect, for each beam of the set of beams, a respective wake-up signal based at least in part on the indication of the angle direction, the indication of the number of repetitions, the indication of the set of beamforming weights, or any combination thereof.

21. The method of claim 14, further comprising:
receiving, from the first wireless device, an indication of a control information reception mode for the controller, wherein communicating the first information is based at least in part on the indication of the control information reception mode indicating a first control information reception mode corresponding to monitoring one or more reception opportunities for the first information.

22. The method of claim 21, further comprising:
receiving, from the first wireless device, a plurality of indications of the control information reception mode for the controller, wherein each indication of indications is associated with a time period.

23. The method of claim 14, further comprising:
transmitting, to the first wireless device, an indication of a control information reception mode for the controller, wherein communicating the first information is based at least in part on transmitting the indication of the control information reception mode.

24. The method of claim 23, further comprising:
transmitting, to the first wireless device, a plurality of indications of the control information reception mode for the controller, wherein each indication of the plurality of indications is associated with a respective component carrier.

25. The method of claim 14, further comprising:
transmitting, to the first wireless device, an indication of a control information reception mode for the controller, wherein communicating the first information is based at least in part on transmitting the indication of the control information reception mode.

26. The method of claim 14, further comprising:
transmitting, to the first wireless device, an indication of a class of controllers to which the controller belongs, wherein communicating the first information with the first wireless device is based at least in part on transmitting the indication of the class of controllers to which the controller belongs.

27. The method of claim 14, wherein
the first information comprises a shared channel transmission indicating a set of beamforming weights, and
the adjustment of the reconfigurable surface is based at least in part on the set of beamforming weights.

28. The method of claim 27, wherein the shared channel transmission comprises a sidelink shared channel transmission indicating the set of beamforming weights, second stage sidelink control information indicating the set of beamforming weights, a medium access control (MAC) control element transmission indicating the set of beamforming weights, or a downlink shared channel transmission indicating the set of beamforming weights.

29. An apparatus for wireless communication at a first wireless device, comprising:
a processor;
memory coupled with the processor; and
instructions stored in the memory and executable by the processor to cause the apparatus to:
receive, from a controller of a reconfigurable surface, an indication of a capability of the controller of the reconfigurable surface to perform one or more operations associated with communications between the controller and the first wireless device;
communicate first information with the controller of the reconfigurable surface based at least in part on receiving the indication of the capability; and
communicate with a second wireless device via the reconfigurable surface, wherein an adjustment for the reconfigurable surface for the communicating with the second wireless device is based at least in part on the first information.

30. An apparatus for wireless communication at a controller of a reconfigurable surface, comprising:
a processor;
memory coupled with the processor; and
instructions stored in the memory and executable by the processor to cause the apparatus to:
transmit, to a first wireless device, an indication of a capability of the controller of the reconfigurable surface to perform one or more operations associated with communications between the controller and the first wireless device;
communicate first information with the first wireless device based at least in part on transmitting the indication of the capability; and
adjust the reconfigurable surface for communications between the first wireless device and a second wireless device based at least in part on the first information.
